(19) United States
(12) Patent Application Publication
(10) Pub. No.: US 2022/0274338 A1
(43) Pub. Date: Sep. 1, 2022

(54) BUILD MATERIAL LOADING

(71) Applicant: HEWLETT-PACKARD DEVELOPMENT COMPANY, L.P., Spring, TX (US)

(72) Inventors: Guillermo MOLINER CLEMENTE, Sant Cugat del Valles (ES); Maria LLORENS SELLES, Sant Cugat del Valles (ES); Carolina BEGARA MARCHAL, Sant Cugat del Valles (ES)

(21) Appl. No.: 17/628,171

(22) PCT Filed: Sep. 16, 2019
(86) PCT No.: PCT/US2019/051227

§ 371 Date: Jan. 18, 2022

(51) Int. Cl. B29C 64/321; B29C 64/357; B29C 64/393; B29C 64/255

(52) U.S. Cl. CPC B29C 64/321; B29C 64/357; B29C 64/393; B29C 64/255; B33Y 30/00

(57) ABSTRACT

A processing station (2) is provided for receiving a build unit (4) of an additive manufacturing system. The processing station (2) has a flow pathway (12) for build material. The flow pathway has a first end 14) connected to a valve arrangement (10) and a second end (16) configured to releasably connect with a build unit (4). The valve arrangement (10) is selectively movable between a first configuration, in which the second end (16) is in fluid communication with a vacuum pump (8) of the processing station, and a second configuration, in which the second end (16) is in fluid communication with a build material reservoir (6) of the processing station.

### BACKGROUND

Additive manufacturing machines produce 3D objects by building up layers of material. Some additive manufacturing machines are commonly referred to as “3D printers”. 3D printers and other additive manufacturing machines make it possible to convert a CAD (computer aided design) model or other digital representation of an object into the physical object. The model data may be processed into slices each defining that part of a layer or layers of build material to be formed into the object. Build material may comprise any suitable form of build material, for example fibres, granules or powders. The build material can include thermoplastic materials, ceramic material and metallic materials.

### BRIEF DESCRIPTION OF THE DRAWINGS

Some non-limiting examples of the present disclosure will be described in the following with reference to the appended drawings in which:

FIG. 1 is a schematic view of a first processing station in accordance with aspects of the present disclosure; and

FIG. 2 is a schematic view of a second processing station in accordance with aspects of the present disclosure.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims. It is to be understood that features of the various examples described herein may be combined, in part or whole, with each other, unless specifically noted otherwise.

In some additive manufacturing processes, a binder is used to bind together particles of a powdered build material to form a solid object. The printing begins with a process of spreading the powdered build material on to the surface of a print area. A powder bed is thereby provided which covers a printing zone. Binder is then jetted at precise locations on to the powder bed to define the geometry of the single or multiple parts to be printed. The process then continues with an energy source assisting with the evaporation of liquid components. This process is repeated until the part or parts are formed layer by layer.

The process is undertaken by an additive manufacturing machine having, for example, two carriages. The first carriage has a roller or spreader that spreads the powder on the top of the print area surface to thereby provide successive layers of powder bed covering a build platform. The roller presses the powder with the aim of maximizing the plane surface. The second carriage has a print nozzle and energy emitter. The print nozzle jets binder at precise locations on to the powder bed to define the geometry of the single or multiple parts to be printed. The energy emitter assists with the evaporation of liquid components of the binder.

In a different example, the process is undertaken by an additive manufacturing machine having one carriage which performs the functions of the two carriages mentioned above. These functions are performed in the same single pass of the carriage over the print area. In a yet further example having one carriage, the functions are performed in more than one pass of the carriage.

The additive manufacturing machine has a build unit and a printer, wherein the printer has a build chamber to receive the build unit, and has the carriage or carriages mentioned above which are movable across the build chamber. The build unit is selectively removable from the build chamber. The mobile build unit has a reservoir of build material and the previously mentioned build platform to receive build material from the build material reservoir.

The build unit is moved to a processing station, remote from the build chamber of printer, to prepare the build unit prior to the printing process. This preparation includes filling the build unit reservoir with build material.

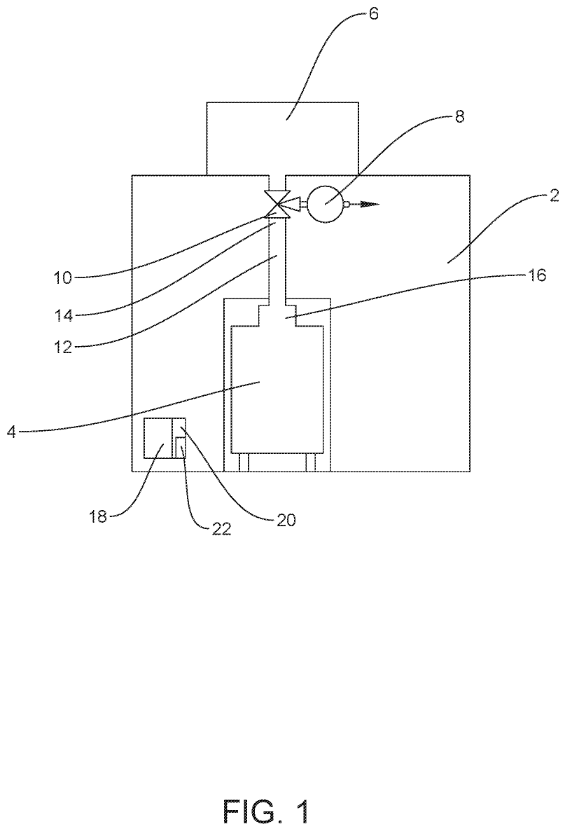

With reference to the accompanying drawings, FIG. 1 shows a processing station 2 in accordance with aspects of the present disclosure. The processing station 2 is shown receiving a build unit 4 of an additive manufacturing system. The processing station 2 has a build material reservoir 6, a vacuum pump 8, a valve arrangement 10, and a flow pathway 12 for build material.

The flow pathway 12 has a first end 14 connected to the valve arrangement 10 and a second end 16 configured to releasably connect with a build unit 4. The valve arrangement 10 is selectively movable between a first configuration, in which the second end 16 of the flow pathway 12 is in fluid communication with the vacuum pump 8, and a second configuration, in which the second end 16 of the flow pathway 12 is in fluid communication with the build material reservoir 6.

During use of the processing station 2, a build unit 4 is connected to the second end 16 of the flow pathway 12. This connection provides fluid communication between the flow pathway 12 and a build material reservoir (not shown) of the build unit 4. With the build unit 4 and flow pathway 12 connected, and with the valve arrangement 10 in the first configuration, the vacuum pump 8 is operated to reduce the fluid pressure within the flow pathway 12 and necessarily also within the build material reservoir of the build unit 4. The vacuum pump 8 is thereby operated to evacuate the build material reservoir of the build unit 4. The vacuum pump 8 is operated to evacuate the build material reservoir of the build unit 4 so that the level of fluid pressure is reduced to between −200 Pa and −800 Pa.

Once a predetermined pressure level (for example, −600 Pa) has been achieved in the flow pathway 12 (and necessarily also within the build material reservoir of the build unit 4), the valve arrangement 10 is moved to the second configuration, in which the second end 16 of the flow pathway 12 is in fluid communication with the build material reservoir 6. With the valve arrangement in this configuration, the build material reservoir of the build unit 4 is in fluid communication with the build material reservoir 6 of the processing station.

The fluid pressure in the build material reservoir 6 of the processing station is considerably greater than that in the build material reservoir of the build unit 4, and once the two reservoirs are placed in fluid communication with one another, fluid flows from the higher pressure reservoir to the lower pressure reservoir. Build material stored in the build material reservoir 6 is in a flowable solid form, and as a consequence, this build material flows from the build material reservoir 6 (the higher pressure reservoir) to the build material reservoir of the build unit 4. In so doing, the build material flows through the valve arrangement 10 and along the flow pathway 12.

In one example, the rate of flow of build material to the built unit 4 is selectively controlled with the valve arrangement 10, which acts to throttle the flow. The speed with which build material is transferred from the build material reservoir 6 of the processing station to the build material reservoir of the build unit 4 is considerably greater than if build material was moved by the action of gravity alone. Also, the low pressure within the build material reservoir of the build unit 4 assists in reducing the volume of build material which might otherwise leak to the surroundings from the flow pathway 12 and from the connection with the build unit 4.

The valve arrangement 10 is operated by an actuator (not shown) of the processing station. In another example, the valve arrangement 10 is operated manually (by hand). In a further example, the valve arrangement 10 is selectively operated manually or by an actuator.

An apparatus 18, in accordance with aspects of the present disclosure, is shown in FIG. 1. The apparatus 18 has a controller 20 to control a processing station 2 of an additive manufacturing system, the controller 20 operating the processing station 2 to reduce fluid pressure in a flow pathway 12 of the processing station 2, wherein the flow pathway 12 is connectable to a build unit 4 of an additive manufacturing system. The controller 20, while pressure in the flow pathway 12 is at a reduced level, operates the processing station 2 to connect the flow pathway 12 with a build material reservoir 6 of the processing station to provide fluid communication between the flow pathway 12 and the build material reservoir 6.

Furthermore, FIG. 1 shows a non-transitory computer-readable storage medium 22 comprising computer executable instructions which, when executed by a processor, cause a processing station 2 of an additive manufacturing system to perform a method. The method operates the processing station 2 to reduce the pressure in a flow pathway 12 of the processing station 2, wherein the flow pathway 12 is connectable to a build unit 4 of an additive manufacturing system. Also, while pressure in the flow pathway 12 is at a reduced level, the method operates the processing station 2 to connect the flow pathway 12 with a build material reservoir 6 of the processing station 2 to provide fluid communication with the build material reservoir 6.

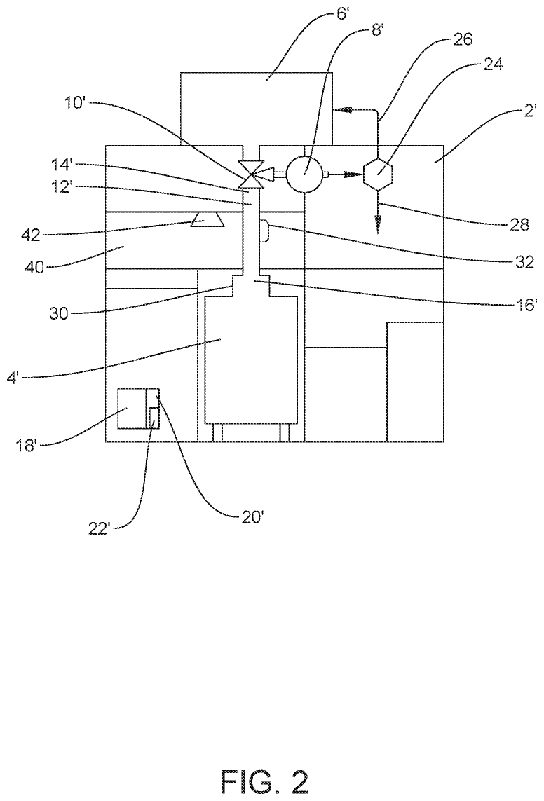

Reference is now made to FIG. 2 of the accompanying drawings. A processing station 2′ for receiving a build unit 4′ of an additive manufacturing system in accordance with aspects of the present disclosure is shown in FIG. 2. The processing station 2′ has features corresponding to those of the processing station shown in FIG. 1, and corresponding features are denoted with like reference numerals in the accompanying drawings. By way of example, the processing station 2 of FIG. 1 has a valve arrangement 10 and the processing station 2′ of FIG. 2 has a valve arrangement 10′.

The processing station 2′ has a separator 24 to separate build material from fluid pumped by the vacuum pump 8′. The separator 24 is of a centrifugal type and is rotationally driven by the motor (not shown) of the vacuum pump 8′. The processing station 2′ has a return flow pathway providing fluid communication between the separator 24 and the build material reservoir 6 to direct separated build material from the separator 24 to the build material reservoir 6. Build material which is separated from fluid by the separator 24 is thereby directed back to the build material reservoir 6 for reuse. Fluid pumped by the vacuum pump 8′ from the flow pathway 12′ and build unit 4′, and from which build material has been separated, is exhausted from the processing station 2′ to the atmosphere via an outlet flow pathway 28.

In other examples, different types of separator are used.

The processing station 2′ also has a releasable seal connector 30 at the second end 16′ of flow pathway 12′ to provide a fluid seal, in use, between the flow pathway 12′ and the build unit 4′. The releasable seal connector 30 allows the build unit 4′ to be repeatedly moved to and from the processing station 2′. Specifically, once the build unit 4′ has been loaded with build material, the releasable seal connector 30 is released from the build unit 4′ to allow the build unit 4′ to be removed from the processing unit 2′ and relocated at a printer. Conversely, if the supply of build material held in the build material reservoir of the build unit 4′ is low and needs replenishing, then the build unit 4′ is located at the processing station 2′ and the releasable seal connector 30 of the processing station 2′ is connected to the build unit 4′. The releasable seal connector 30 provides an air tight seal between the flow pathway 12′ of the processing station 2′ and build unit 4′. The seal is sufficient to prevent leakage of fluid during the low pressure level generated by the vacuum pump 8′.

The releasable seal connector 30 is operated manually. In a different example, the releasable seal connector connects with the build unit 4′ automatically (without the intervention of a human operator) in response to the build unit 4′ being received by the processing station 2′.

The valve arrangement 10′ is a three way valve. In the first configuration of the valve arrangement 10′, fluid communication between the flow pathway 12 and the build material reservoir 6 is prevented. When in this configuration, the vacuum pump 8′ is in fluid communication with the flow pathway 12′ and is operated to reduce the pressure in the flow pathway 12′ and, consequently, in the build material reservoir of a build unit 4′ connected to the processing station 2′. Build material present in the flow pathway 12′ and the valve arrangement 10′ will be drawn through the separator 24 and returned to the build material reservoir 6′.

The controller 20′ operates the vacuum pump 8 to reduce fluid pressure in the flow pathway but only after determining that fluid communication between the flow pathway 12′ and the build material reservoir 6′ of the processing station is prevented. This determination is made, for example, with reference to the configuration of the valve arrangement.

Once a predetermined reduced pressure has been achieved, the valve arrangement 10′ is moved towards the second configuration.

In the second configuration of the valve arrangement 10, fluid communication between the flow pathway 12′ and the vacuum pump 8 is prevented. When in this configuration, the build material reservoir 6′ is in fluid communication with the flow pathway 12′ and is exposed to the reduced level of pressure previously generated by the vacuum pump 8′ in the build unit 4′. The pressure in the processing station 2′ and build unit 4′ equalises by a movement of fluid and build material from the build material reservoir 6′ to the build material reservoir of the build unit 4′.

In one example, the build material reservoir 6′ is provided with an inlet (not shown) and the flow of build material from the build material reservoir 6′ is selectively assisted by opening the inlet in the build material reservoir 6′ to allow ambient air to enter the build material reservoir 6′. Conversely, the rate of flow of build material from the build material reservoir 6′ is selectively reduced by moving the valve arrangement 10′ towards the first configuration. This movement configures the valve arrangement 10′ to partially restrict flow through the valve arrangement 10′ from the build material reservoir 6′ to the build unit 4′, while the vacuum pump 8′ is retained isolated (in other words, the vacuum pump 8′ is not in fluid communication with the flow pathway).

The processing station 2′ has a pressure sensor 32 to measure pressure of fluid in fluid communication with the flow pathway 12′. The processing station 2′ also has a controller to receive and process measurement data from the pressure sensor 32. The controller is the controller 20′ described above to control the processing station 2.

The controller 20′ is configured to determine if a profile of measurement data satisfies predetermined requirements. In one example, the predetermined requirements are a specific level of reduced pressure in the flow pathway 12′. In use, when the specific level of reduced pressure in the flow pathway 12′ is sensed by the pressure sensor 32, the controller 20′ operates the valve arrangement 10′ to move the valve arrangement 10′ from the first configuration to the second configuration. The controller 20′ makes the connection of the flow pathway 12′ with the build material reservoir 6′ only once the controller 20′ has stopped reducing fluid pressure in the flow pathway (for example, by stopping operation of the vacuum pump).

The controller 20′ operates the valve arrangement 10′ to move the valve arrangement 10′ from the second configuration to the first configuration. In one example, this movement is in response to the releasable seal connector 30 being released from the build unit 4′. The controller 20′ also then operates the vacuum pump 8′ for a short period of time to prevent build material in the flow pathway 12′ from falling out of the flow pathway 12′ and being lost. Rather, the vacuum pump 8′ operates to draw build material in the flow pathway 12′ into the separator 24 from where it is returned to the build material reservoir 6′.

The controller 20′ is configured to indicate if a profile of measurement data does not satisfy predetermined requirements. In one example, the predetermined requirements is a specific level of reduced pressure in the flow pathway 12′ after a given period of time during which the vacuum pump 8′ has been in operation. If the pressure in the flow pathway 12′ reduces more slowly than expected, or not at all, then this is indicative of a leak at the releasable seal connection 30, in the build material reservoir of the build unit 4′, or elsewhere. A warning signal is then presented to the user and remedial action can be taken.

The present disclosure provides a method of determining the integrity of a connection between a build unit of an additive manufacturing system and a processing station, wherein the connection provides fluid communication between the build unit and a flow pathway of the processing station. The method includes operating the processing station to pump fluid from the flow pathway of the processing station; monitoring the fluid pressure in the flow pathway with time; and determining whether the monitored fluid pressure in the flow pathway with time is indicative of a leak in one of (i) the connection between the build unit and the processing station, and (ii) the build material reservoir of the build unit.

The build material reservoir 6′ has a mixer. Also, the build material reservoir 6′ is located directly above the area where the processing station 2′ receives a build unit 4′, and the flow pathway 12′ extends vertically downwards from the build material reservoir 6′. This arrangement allows the action of gravity on build material to assist in moving build material from the build material reservoir 6′ to the build unit 4′.

Furthermore, the processing station 2′ has a post processing bay 40 with dust extractor 42, wherein a 3D printed item is post processed.

Build material may comprise any suitable form of build material, for example short fibres, granules or powders. A powder may include short fibres that may, for example, have been cut into short lengths from long strands or threads of material. The build material can include thermoplastic materials, ceramic material and metallic materials. Binders may include chemical binder systems, such as in Binder Jet or metal type 3D printing. Binders or fusing agents may be used as appropriate.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited by the claims and the equivalents thereof.

1. A processing station for receiving a build unit of an additive manufacturing system, the processing station comprising:
a build material reservoir,
a vacuum pump,
a valve arrangement, and
a flow pathway for build material, the flow pathway having a first end connected to the valve arrangement and a second end configured to releasably connect with a build unit,
wherein the valve arrangement is selectively movable between a first configuration, in which the second end of the flow pathway is in fluid communication with the vacuum pump, and a second configuration, in which the second end of the flow pathway is in fluid communication with the build material reservoir.

2. The processing station of claim 1, wherein in the first configuration of the valve arrangement, fluid communication between the flow pathway and the build material reservoir is prevented.

3. The processing station of claim 1, wherein in the second configuration of the valve arrangement, fluid communication between the flow pathway and the vacuum pump is prevented.

4. The processing station of claim 1, wherein the valve arrangement comprises a three way valve.

5. The processing station of claim 1, wherein the build material reservoir comprises a mixer.

6. The processing station of claim 1, further comprising a separator to separate build material from fluid pumped by the vacuum pump.

7. The processing station of claim 6, further comprising a return flow pathway providing fluid communication between the separator and the build material reservoir to direct separated build material from the separator to the build material reservoir.

8. The processing station of claim 1, further comprising a releasable seal connector at the second end of flow pathway to provide a fluid seal, in use, between the flow pathway and the build unit.

9. The processing station of claim 1, further comprising a pressure sensor to measure pressure of fluid in fluid communication with the flow pathway, and a controller to receive and process measurement data from the pressure sensor, the controller configured to indicate if a profile of measurement data does not satisfy predetermined requirements.

10. Apparatus comprising a controller to control a processing station of an additive manufacturing system, the controller operating the processing station to reduce fluid pressure in a flow pathway of the processing station, wherein the flow pathway is connectable to a build unit of an additive manufacturing system; and the controller, while pressure in the flow pathway is at a reduced level, operating the processing station to connect the flow pathway with a build material reservoir of the processing station to provide fluid communication between the flow pathway and the build material reservoir.

11. The apparatus of claim 10, wherein the controller reduces fluid pressure in the flow pathway by operating a vacuum pump only after determining that fluid communication between the flow pathway and the build material reservoir of the processing station is prevented.

12. The apparatus of claim 10, wherein the controller makes the connection of the flow pathway with the build material reservoir only once the reduced level of pressure in the flow pathway satisfies predetermined requirements.

13. The apparatus of claim 10, wherein the controller makes the connection of the flow pathway with the build material reservoir only once the controller has stopped reducing fluid pressure in the flow pathway.

14. A non-transitory computer-readable storage medium comprising computer executable instructions which, when executed by a processor, cause a processing station of an additive manufacturing system to perform a method, the method comprising:
operating the processing station to reduce the pressure in a flow pathway of the processing station, wherein the flow pathway is connectable to a build unit of an additive manufacturing system; and
while pressure in the flow pathway is at a reduced level, operating the processing station to connect the flow pathway with a build material reservoir of the processing station to provide fluid communication with the build material reservoir.

15. The non-transitory computer-readable storage medium of claim 14, wherein the connection of the flow pathway with the build material reservoir is made only once the reduced level of pressure in the flow pathway satisfies predetermined requirements and, the method further comprising indicating if the predetermined requirements are not satisfied.
